(19) United States
(12) Patent Application Publication
(10) Pub. No.: US 2026/0143201 A1
(43) Pub. Date: May 21, 2026

(54) GENERATING TRAINING DATA USING A GENERATIVE NEURAL NETWORK

(71) Applicant: DeepMind Technologies Limited, London (GB)

(72) Inventors: Sonam Goenka, Sunnyvale, CA (US); Sergi Caelles Prat, Zürich (CH); Josip Djolonga, Zürich (CH); Filip Pavetic, Zürich (GB); Javier Snaider Scher, Mountain View, CA (US); Apostol Ivanov Natsev, Sunnyvale, CA (US); Mario Lucic, Adliswil (CH); Anja Hauth, Baar (CH); Hyodong Lee, Santa Clara, CA (US)

(21) Appl. No.: 18/951,101

(22) Filed: Nov. 18, 2024

(51) Int. Cl. H04N 21/488; G06V 10/80; G06V 10/82

(52) U.S. Cl. CPC H04N 21/488; G06V 10/811; G06V 10/82

(57) ABSTRACT

Methods, systems, and apparatus, including computer programs encoded on computer storage media, for generating a dataset for training a video processing model. One of the methods includes obtaining a video that comprises a plurality of video frames; for each of one or more segments of the video: providing one or more video frames of the segment as input to a video captioning model to generate a set of one or more respective captions, each describing content depicted in the segment; providing at least the set of respective captions as input to a summarization model to generate a corresponding annotation for the segment; and generating a data sample comprising at least data representing the video and data representing the corresponding annotation for each of the one or more segments of the video; and adding the data sample to a dataset.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations for generating a dataset for training a video processing model.

According to one aspect there is provided a computer-implemented method comprising: obtaining a video that comprises a plurality of video frames; for each of one or more segments of the video, wherein each segment comprises one or more consecutive video frames of the video: providing one or more video frames of the segment as input to a video captioning model to generate a set of one or more respective captions, each describing content depicted in the segment; providing at least the set of respective captions as input to a summarization model to generate a corresponding annotation for the segment; and generating a data sample comprising at least data representing the video and data representing the corresponding annotation for each of the one or more segments of the video; and adding the data sample to a dataset.

In some implementations, the method further comprises: generating, from the dataset, training data for training a video processing model; and training the video processing model on the training data.

In some implementations, the video processing model is the video captioning model.

In some implementations, the one or more segments of the video are identified from the video by: obtaining a transcript of speech represented in the video; and identifying the one or more segments based on one or more portions of text in the transcript, each corresponding to a segment of the video.

In some implementations, identifying the one or more segments based on one or more portions of text in the transcript comprises identifying the one or more segments based on a respective timing of the one or more portions of text.

In some implementations, the one or more segments of the video are identified from the video by dividing the video into the one or more segments that each meet a threshold duration.

In some implementations, providing one or more video frames of the segment as input to the video captioning model comprises providing the plurality of video frames of the video as input to the video captioning model.

In some implementations, providing one or more video frames of the segment as input to the video captioning model comprises providing only a particular video frame of the consecutive video frames of the segment as input to the video captioning model.

In some implementations, the method further comprises determining one or more key video frames of the video by: generating, for each video frame of the video, a respective frame embedding; determining, for each consecutive pair of video frames, a respective difference between the respective frame embedding for a first video frame of the consecutive pair, and the respective frame embedding for a second video frame of the consecutive pair; determining, for each consecutive pair of video frames, whether the respective difference meets a threshold difference; and for each consecutive pair of video frames, in response to determining that the respective difference meets a threshold difference, determining that the second video frame of the consecutive pair is a key video frame.

In some implementations, providing one or more video frames of the segment as input to the video captioning model comprises: identifying one or more of the key video frames as belonging to the segment; and providing one or more of the identified key video frames as input to the video captioning model.

In some implementations, generating a data sample comprising at least data representing the video and data representing the corresponding annotation for each of the one or more segments of the video comprises generating a combined annotation by combining each corresponding annotation.

In some implementations, the combined annotation comprises one or more indices, each identifying a corresponding segment of the video.

In some implementations, generating a data sample comprising at least data representing the video and data representing the corresponding annotation for each of the one or more segments of the video further comprises including, at each of the one or more indices, data representing the corresponding segment of the video identified by the index.

In some implementations, generating a data sample comprising at least data representing the video and data representing the corresponding annotation for each of the one or more segments of the video further comprises including, at each of the one or more indices, data representing a corresponding audio signal of the corresponding segment of the video identified by the index.

In some implementations, data representing the corresponding audio signal comprises one or more audio samples of the corresponding audio signal, or a sequence of audio tokens representing the audio samples of the corresponding audio signal.

In some implementations, data representing the video comprises the video frames of the video, or a sequence of video tokens representing the video frames of the video.

In some implementations, data representing, for each of the one or more segments of the video, the corresponding annotation, comprises text, or a sequence of text tokens representing the text.

In some implementations, the method further comprises obtaining one or more respective text sequences corresponding to the video, and wherein providing at least the set of respective captions as input to a summarization model to generate a corresponding annotation for the segment comprises providing the set of respective captions and the one or more respective text sequences as input to the summarization model.

In some implementations, the one or more respective text sequences comprise any one or more of: a title of the video, a description of the video, text specifying one or more entities depicted in the video, or a transcript of speech represented in the video.

According to another aspect there are provided one or more non-transitory computer storage media encoded with computer program instructions that when executed by a plurality of computers cause the plurality of computers to perform the respective operations of the methods described herein.

According to another aspect there is provided a system comprising one or more computers and one or more storage devices storing instructions that are operable, when executed by the one or more computers, to cause the one or more computers to perform the respective operations of the methods described herein.

Particular embodiments of the subject matter described in this specification can be implemented so as to realize one or more of the following advantages.

Training video processing models to perform tasks such as video understanding requires a large set of training data. Obtaining a large amount of training data for these tasks, e.g., where each training sample includes video data and text describing the content of the video data, can be difficult. In particular, obtaining text describing the content of long videos can be difficult. Unlike conventional approaches, the system described in this specification can effectively generate a dataset that includes data representing videos of different lengths and data representing annotations for the videos without requiring any pre-generated annotations. Once generated, the dataset can be used to generate training data for any of a variety of tasks.

In some examples, the system can train the video processing model on the training data. In some examples, the system can use the training samples as few-shot examples for the video processing model.

The system described in this specification can generate the dataset by using one or more machine learning models, such as a video captioning model and a summarization model, to generate synthetic annotations for videos. By using the one or more machine learning models to generate a dataset with synthetic annotations for videos, the system increases the number of training samples available for training, resulting in improved training and performance of the video processing model compared to a video processing model trained on a limited amount of training data.

In some examples, the system can use the same machine learning model as the video captioning model and the summarization model. By making use of a single model, the system can reduce the amount of computing resources required to maintain and perform inference compared to using multiple machine learning models.

In some examples, the video captioning model and the video processing model are the same machine learning model. For example, the video processing model can have been pre-trained to perform video captioning. In these examples, the system can use a current version of the video processing model to generate training data for a future version of the video processing model, i.e., for fine-tuning the video processing model to perform an additional task that requires processing videos. For example, the video processing model can be trained to perform different tasks other than video captioning, e.g., question answering. As another example, the video processing model can be trained to have better performance for the video captioning task, e.g., to generalize better to different videos at inference or to perform better on videos of different lengths at inference. By using the video processing model as the video captioning model, the system can reduce the amount of computing resources required to train the video processing model compared to training a separate video captioning model and video processing model.

The system described in this specification generates a multimodal dataset that includes data representing multiple types of data for each video, such as audio, video, or text. The system can generate training samples for multiple tasks from the multimodal dataset, allowing for flexibility. In addition, the multimodal dataset can include audio, video, or text data, or tokens representing the audio, video, or text data. The system can generate training samples for video processing models of different architectures or that are configured to receive different inputs, further allowing for flexibility.

Moreover, the system described in this specification can generate annotations of videos in a computationally efficient manner. In some examples, the system can determine one or more key video frames of the video, and provide the one or more key video frames as input to the video captioning model. The system can reduce the number of video frames to process in situations without a threshold amount of change between consecutive video frames, reducing the computing time and resources required to process long videos. In some examples, the system can provide only a particular video frame of a video as input to the video captioning model. The system can process only a single video frame, reducing the computing time and resources required to process short and long videos. Thus the system can process videos of different lengths differently to generate annotations in a computationally efficient manner while retaining important content of the videos.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example system for generating data samples.

FIB. 1B shows another example system for generating data samples.

FIG. 2 shows another example system for generating data samples.

FIG. 3 shows another example system for generating data samples.

FIG. 4A shows an example data sample.

FIG. 4B shows another example data sample.

FIG. 5 is a flow diagram of an example process for generating a dataset of data samples.

Like reference numbers and designations in the various drawings indicate like elements.

### DETAILED DESCRIPTION

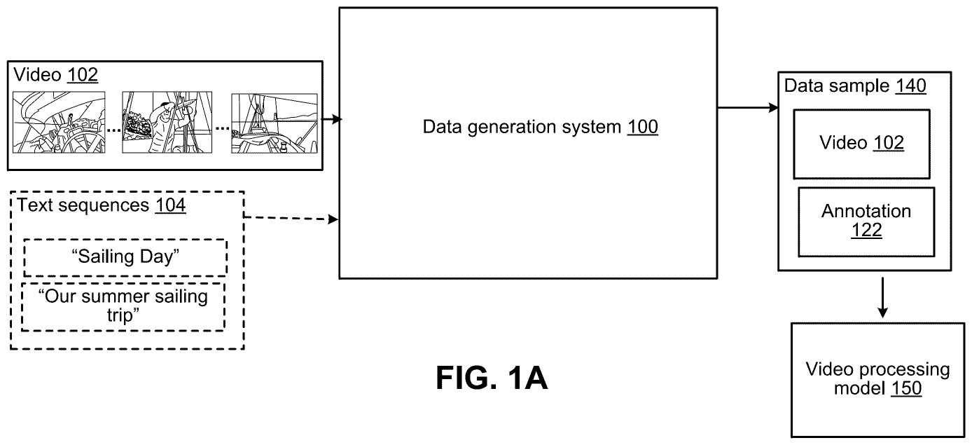

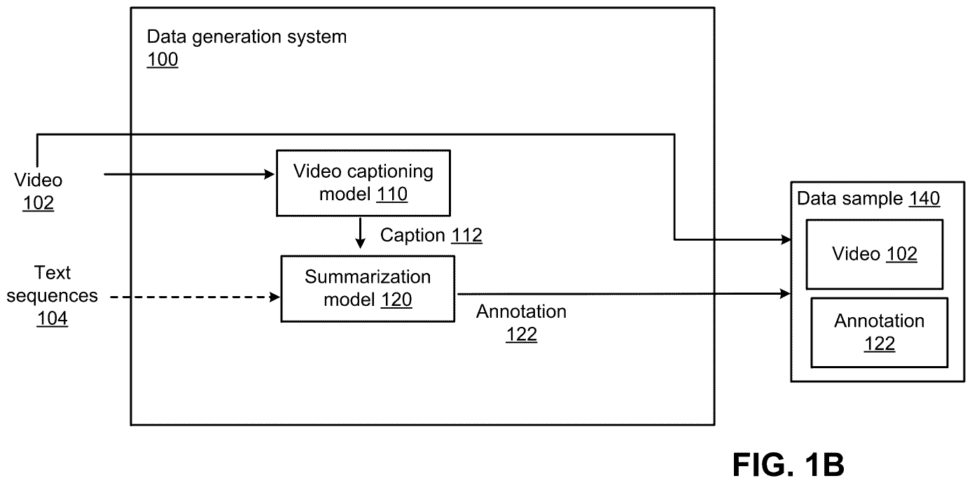

FIG. 1A shows an example system 100 for generating data samples. The system 100 is an example of a system implemented as computer programs on one or more computers in one or more locations in which the systems, components, and techniques described below are implemented.

The system 100 generates data samples such as the data sample 140 for inclusion in a dataset. Each data sample includes data representing a video and data representing one or more annotations for the video. For example, data representing the video can include multiple video frames or video tokens representing the video. Data representing the annotation of the video can include, for example, text such as natural language text or code, or audio. As a particular example, the data representing the annotation of the video can include a natural language sequence of text, or text tokens representing the natural language sequence.

Each of the one or more annotations for the video characterizes content of a segment of the video and metadata of the video. Each segment includes one or more consecutive video frames of the video. In some examples, such as in FIG. 1, one segment includes all of the video frames of the video, i.e., the video is made up of a single segment. In some other examples, the video includes multiple different segments.

Once the system 100 has generated the data samples, the system 100 can generate training samples for training, e.g., for training from scratch or for further training, a video processing model 150. For example, the system 100 can generate one or more training samples for each data sample. For each data sample, a corresponding training sample can include a training input that includes at least the video of the data sample, and a training output derived from the one or more annotations of the data sample. A training system of the system 100 or another training system can train the video processing model 150 on the training data generated by the data generation system 100.

The video processing model 150 can be configured to perform a video processing task, e.g., by processing one or more inputs in accordance with current values of parameters of the video processing model 150 to generate an output. For example, the video processing model 150 can be configured to receive an input video and to generate an output appropriate for the task for the input video. As a particular example, the task can be video captioning and the output can include a text caption of the content of the input video. As another example, the task can be question answering and the output can include a text answer to a given question about the video.

The video processing model 150 can have any appropriate architecture for performing a video processing task. For example, the video processing model 150 can have any appropriate neural network architecture, such as a language model neural network architecture, that allows the model to map an input sequence of tokens from a vocabulary to an output sequence of tokens from the vocabulary.

For example, the video processing model 150 can have any appropriate Transformer-based architecture, e.g., encoder-only Transformer architectures, encoder-decoder Transformer architectures, decoder-only Transformer architectures, other attention-based architectures, and so on. Examples of such Transformer-based neural network architectures include those described in Gemini Team, et al. Gemini: a family of highly capable multimodal models. arXiv preprint arXiv:2312.11805 (2023).

In general a Transformer-based architecture can be one which is characterized by having a succession of self-attention neural network layers. A self-attention neural network layer has an attention layer input for each element of the input and is configured to apply an attention mechanism over attention layer inputs to generate an attention layer output for each element of the input. There are many different attention mechanisms that may be used.

For example, the video processing model 150 can include a multimodal language model neural network. The input sequence can include tokens representing data of one or more modalities, and the output sequence can include tokens representing data of one or more modalities. As a particular example, the input sequence can include tokens representing text and video, and the output sequence can include tokens representing text.

The vocabulary of tokens can include any of a variety of tokens that represent text symbols or other symbols. For example, the vocabulary of tokens can include one or more of characters, sub-words, words, punctuation marks, numbers, or other symbols that appear in a corpus of natural language text and/or computer code. Additionally, the vocabulary of tokens can include tokens that can represent data other than text. For example, the vocabulary of tokens can include image tokens that represent a discrete set of image patch embeddings of an image that can be generated by an image encoder neural network based on processing the image patches of the image. As another example, the vocabulary of tokens can include video tokens that represent spatial-temporal dynamics of a video that can be generated by a video encoder neural network based on processing the video frames of the video. As another example, the vocabulary of tokens can include audio tokens that represent code vectors in a codebook of a quantizer, e.g., a residual vector quantizer. As an example, the language model neural network can generate text sequences, i.e., each output sequence generated by the language model neural network is a sequence of text tokens from a vocabulary of text tokens that includes, e.g., one or more of characters, sub-words, words, punctuation marks, numbers, or other symbols that appear in natural language text.

As another example, the language model neural network can generate images or videos that each have multiple frames (where each frame is an image) by generating images as sequences of pixels. For example, each output sequence generated by the language model neural network is a sequence of color values for pixels in an image arranged according to a specified order. As another example, each output sequence generated by the language model neural network is a sequence of tokens that represent image patch embeddings of an image which can then be processed by a decoder neural network to generate the image (pixel values).

In particular, the language model neural network can be an auto-regressive neural network that auto-regressively generates the output sequence of tokens by generating each particular token in the output sequence conditioned on a current input sequence that includes (i) the input sequence followed by (ii) any tokens that precede the particular token in the output sequence.

More specifically, to generate a particular token, the language model neural network can process the current input sequence to generate a score distribution, e.g., a probability distribution, that assigns a respective score, e.g., a respective probability, to each token in the vocabulary of tokens. The language model neural network can then select, as the particular token, a token from the vocabulary using the score distribution. For example, the language model neural network can greedily select the highest-scoring token or can sample, e.g., using top-k sampling, nucleus sampling or another sampling technique, a token from the distribution.

In some examples, the language model neural network is pre-trained, e.g., by the system 100 or by one or more other systems. As an example, the system 100 or the other system(s) can pre-train the language model neural network on a language modeling task, e.g., a task that requires predicting, given a current sequence of text tokens, the next token that follows the current sequence in the training data.

In some examples, other components such as the image encoder neural network or video encoder neural network can be pre-trained, e.g., by the system 100 or by one or more other systems.

The image encoder neural network can have any appropriate neural network architecture that allows the image encoder neural network to map an image patch to an embedding. For example, the image encoder neural network can include any appropriate types of neural network layers (e.g., embedding layers, fully connected layers, attention layers, and so forth) in any appropriate number (e.g., 2 layers, or 5 layers, or 10 layers) and connected in any appropriate configuration (e.g., as a directed graph of layers).

As an example, an image encoder neural network can be pre-trained on unlabeled training data based on optimizing a self-supervised or unsupervised loss function to generate vectors in an embedding space that have a fixed dimensionality. In some implementations, the image encoder neural network can be trained as part of another neural network (that e.g. have a larger architecture) on tasks that involve generating embedding space representations, e.g., image classification tasks.

The video encoder neural network can have any appropriate neural network architecture that allows the video encoder neural network to map one or more patches of one or more video frames to an embedding. For example, the video encoder neural network can include any appropriate types of neural network layers (e.g., embedding layers, fully connected layers, attention layers, and so forth) in any appropriate number (e.g., 2 layers, or 5 layers, or 10 layers) and connected in any appropriate configuration (e.g., as a directed graph of layers).

As an example, a video encoder neural network can be pre-trained on unlabeled training data based on optimizing a self-supervised or unsupervised loss function to generate vectors in an embedding space that have a fixed dimensionality. In some implementations, the video encoder neural network can be trained as part of another neural network (that e.g. have a larger architecture) on tasks that involve generating embedding space representations, e.g., video understanding tasks.

In some examples, the system can train the video processing model 150 by training the language model neural network while holding other components, e.g., the image encoder neural network, or the video encoder neural network, fixed.

As part of generating the dataset of data samples, the system 100 receives a video 102. The video 102 includes multiple video frames. Each video frame is an image that includes multiple pixels that each has one or more intensity values. In the example of FIG. 1A, the video 102 depicts people on a boat.

In some examples, the system 100 also obtains text sequences 104 corresponding to the video 102. In some examples, the text sequences 104 can include metadata such as a title for the video 102, a description for the video 102, a transcript of speech represented in the video 102, or text specifying one or more entities depicted in the video 102. The description for the video includes natural language text describing what the video 102 is about.

In the example of FIG. 1A, the text sequences 104 include a title for the video 102, “Sailing Day,” and a description for the video 102, “Our summer sailing trip.”

In some examples, the system 100 can obtain the metadata from a database. For example, the system 100 can obtain the title and the description from a database that includes videos, titles for the videos, and descriptions for the videos.

In some examples, the system 100 can generate the metadata. For example, the system 100 can generate the transcript of speech by processing the video 102 using a video transcription model. As another example, the system 100 can generate the text specifying one or more entities depicted in the video using a video understanding model, e.g., that performs object detection or action recognition on input videos.

The system generates one or more annotations such as the annotation 122 from the video 102 and, in some examples, the text sequences 104. Each annotation summarizes content depicted in at least one segment of the video 102, and in some examples, the text sequences 104. In the example of FIG. 1A, the annotation 122 summarizes the content depicted in the video 102 and the text sequences 104.

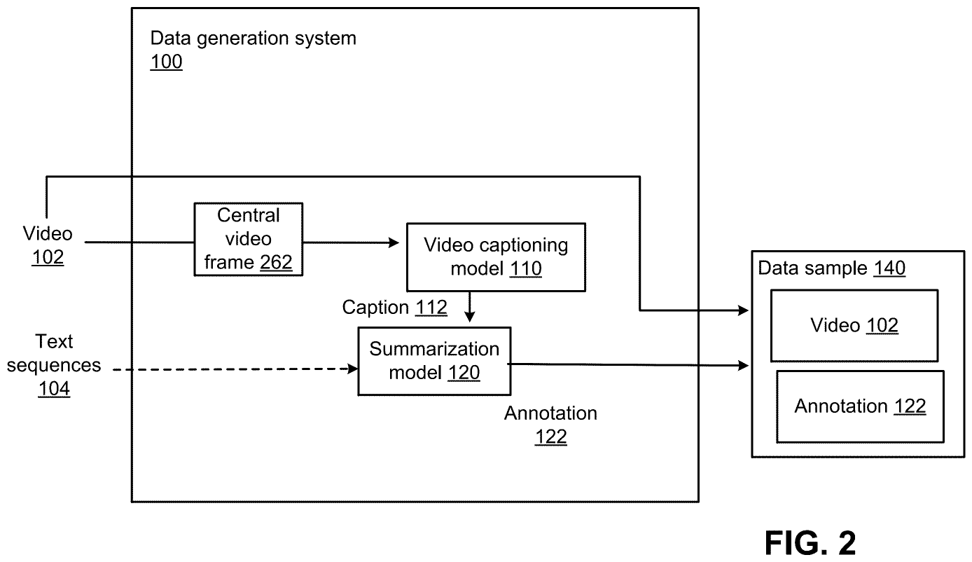

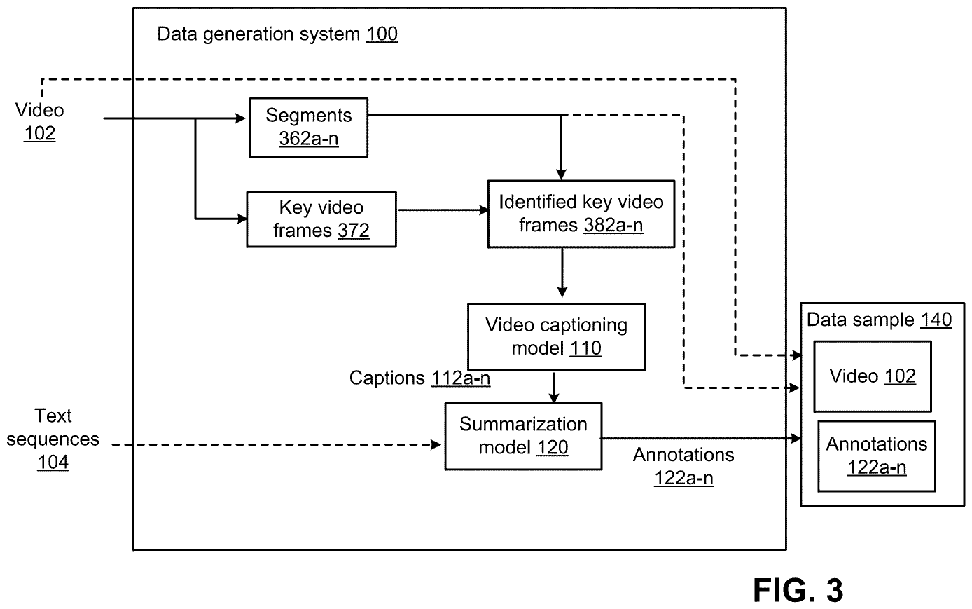

To generate the annotation 122, the system 100 can use one or more machine learning models as described below with reference to FIG. 1B, and FIGS. 2-3. More specifically, generating the annotation 122 for a video that includes one segment is described in more detail with reference to FIG. 1B and FIG. 2, while generating annotations for a video that includes multiple segments is described in more detail with reference to FIG. 3.

The system 100 generates the data sample 140 for including in the dataset, i.e., in a set of multiple data samples. Each data sample includes data representing a video and data representing the one or more annotations for the video. For example, the data sample 140 includes the video 102 and the annotation 122.

In some examples, the data sample 140 includes video tokens representing the video 102 and text tokens representing the annotation 122. For example, the system 100 can generate the video tokens by processing the video 102 using a video tokenizer. In some examples, the system can generate the text tokens by processing the annotation 122 using a text tokenizer. In some examples, the system can obtain the text tokens from the one or more machine learning models.

In some examples, the data sample 140 includes data representing audio of the video 102. For example, the data sample 140 can include an audio signal or audio tokens representing the audio signal.

In some examples, the system 100 can obtain the data representing audio of the video 102 from the video 102. For example, the system 100 can extract an audio signal from the video 102. In some examples, the system 100 can tokenize the audio signal to generate the audio tokens, e.g., semantic tokens, acoustic tokens, or both, representing the audio signal. Examples of generating semantic tokens and acoustic tokens, e.g., using a neural audio codec or an audio processing neural network, are described in more detail in Borsos, Zalán, et al. “Audiolm: a language modeling approach to audio generation.” IEEE/ACM Transactions on Audio, Speech, and Language Processing (2023), Kharitonov, Eugene, et al. “Speak, read and prompt: High-fidelity text-to-speech with minimal supervision.” Transactions of the Association for Computational Linguistics 11 (2023): 1703-1718, and Agostinelli, Andrea, et al. “Musiclm: Generating music from text.” arXiv preprint arXiv:2301.11325 (2023).

The system 100 can generate data samples such as the data sample 140 for a large number of different videos, e.g., videos of different lengths, videos that depict different content, videos with different resolutions, or videos with different corresponding text sequences. The system 100 can thus generate a large dataset of annotations for different videos that can be used to generate training data for training the video processing model 150 to perform a variety of tasks.

In some examples, the system 100 can generate the training data from the data samples. For a task such as video captioning, for each data sample, the system 100 can generate a training sample that includes the video of the data sample as a training input, and the one or more annotations of the training sample as the training output.

For a task such as question answering, the training samples can each include a video and a question about the video as a training input, and the answer to the question as the training output. For example, the system 100 can generate the question and the answer by processing the one or more annotations using a language model neural network. As a particular example, the system 100 can provide the one or more annotations and an instruction to generate a question and an answer from the one or more annotations as input to the language model neural network.

As another example, the training samples can each include a portion of a video that depicts a sequence of actions or steps and a question about the next actions as the training input, and the answer to the question that includes a description of one or more next actions as the training output. For example, the system 100 can generate the training sample from an interleaved data sample. As an example, the system 100 can include the video frames of one or more consecutive segments in the training input. In some examples, the system 100 can generate the question by processing the one or more annotations using a language model neural network. For example, the system 100 can provide the one or more annotations and an instruction to generate a question about what should happen next in the type of sequence depicted in the video as input to the language model neural network.

The system 100 can derive the training output from the corresponding annotation for the subsequent segment in the training output. In some examples, the system 100 can include the corresponding annotation for the subsequent segment in the training output. In some examples, the system 100 can generate the answer by processing the corresponding annotation for the subsequent segment using a language model neural network. For example, the system 100 can provide the corresponding annotation for the subsequent segment and an instruction to extract the actions from the corresponding annotation as input to the language model neural network.

In examples where the data sample 140 includes data representing audio of the video 102, the system 100 can include the video and the audio in the training input. For example, for a task such as video captioning, training the video processing model 150 with training inputs that include video and audio can result in better performance at inference given input videos.

In some examples, instead of or in addition to using the dataset for training, the system can use the training samples as few-shot examples for the video processing model 150. Each few-shot example can include a training input and the corresponding training output for a particular task. For example, for a task such as video captioning, each few-shot example can include a video as the training input and the one or more annotations for the video as the training output. As another example, for interleaved data samples, each few-shot example can include video frames of one or more segments of a video as the training input, and the corresponding annotations for the segments as the training output. To generate a caption for a particular video at inference, the system can provide the few-shot examples and the particular video as input to the video processing model 150.

Training the video processing model 150 on training data generated by the system 100 results in better performance at inference compared to a video processing model trained on a limited amount of training data. For example, training the video processing model on a larger number and greater variation of training samples allows the video processing model 150 to generalize better to previously unseen inputs at inference.

In some examples, the system 100 can generate the data sample 140 as described with reference to FIG. 1B, FIG. 2, or FIG. 3. For example, the system 100 can generate the data sample 140 based on the length or number of video frames of the video 102. For example, for a video that is shorter than a minimum threshold duration, e.g., shorter than twenty, ten, or six seconds, the system 100 can generate the data sample 140 as described with reference to FIG. 2. For a video that is longer than a maximum threshold duration, e.g., longer than two minutes, three minutes, or four minutes, the system 100 can generate the data sample 140 as described with reference to FIG. 3. For a video that is in between the minimum and maximum threshold duration, the system 100 can generate the data sample 140 as described with reference to FIG. 1B.

FIG. 1B shows the example data generation system 100 described above with FIG. 1A. In particular, in the example of FIG. 1B, the video 102 is in between a minimum and maximum threshold duration, or has a number of video frames that is in between a minimum and maximum threshold number of video frames. The system 100 generates a data sample 140 that includes an annotation 122 for the video 102 using a video captioning model 110, and a summarization model 120.

The system 100 obtains the video 102 and, in some examples, the text sequences 104 as described above with reference to FIG. 1A.

The system 100 provides the multiple video frames of the video 102 as input to the video captioning model 110 to generate a caption 112. The caption 112 includes natural language text describing content depicted in the video 102, i.e., depicted by the pixels of one or more of the video frames in the video 102. In the example of FIG. 1A, the caption 112 describes content depicted by the pixels of the video frames in the video 102.

The video captioning model 110 is configured to generate text describing content depicted in one or more input video frames. An example video captioning model is described above as the video processing model described above with reference to FIG. 1B. In some examples, the video captioning model 110 and the video processing model 150 can be the same machine learning model.

The system 100 provides at least the caption 112 as input to the summarization model 120 to generate a corresponding annotation 122. In some examples, the system 100 also provides the text sequences 104 as input to the summarization model 120. The corresponding annotation 122 includes natural language text that summarizes the content of the caption 112 and, in some examples, the text sequences 104. Thus in the example of FIG. 1B, the corresponding annotation 122 summarizes the content of the text sequences 104 and the content depicted in the video 102.

The summarization model 120 is configured to generate text that is a summarization of input text. For example, the summarization model 120 can include a language model neural network. In some examples, the summarization model 120 and the video captioning model 110 can be the same machine learning model.

The system 100 generates the data sample 140 to include the annotation 122 and the video 102. In the example of FIG. 1B, the data sample 140 is a paired data sample. Each paired data sample can include a video and one or more annotations for the video. For example, the example 140 can include <video 102, annotation 122>.

FIG. 2 shows the example data generation system 100 described above with FIG. 1A. In particular, in the example of FIG. 2, the video 102 is shorter than a minimum threshold duration, or has a number of video frames that is less than a minimum threshold number of video frames. The system 100 generates a data sample 140 that includes an annotation 122 for the video 102 using the video captioning model 110, and the summarization model 120.

The system 100 obtains the video 102 and, in some examples, the text sequences 104 as described above with reference to FIG. 1A.

In the example of FIG. 2, the system 100 provides only a particular video frame of the video 102 as input to the video captioning model 110.

For example, the system 100 can process the video 102 to identify the particular video frame. For example, the particular video frame can be a central video frame 262. The central video frame 262 has a video frame index in the middle or near the middle of the video frame indices of the video 102. In some cases, such as where the video 102 has an odd number of video frames, the central video frame 262 has a video frame index in the middle, e.g., the number of video frames divided by two, of the video frame indices of the video 102. In other cases, such as where the video 102 has an even number of video frames, the central video frame 262 has a video frame index, the central video frame 262 can have a video frame index that is the floor of the number of video frames divided by two, or the ceiling of the number of video frames divided by two.

The system 100 provides the central video frame 262 as input to the video captioning model 110 to generate the caption 112, as described above with reference to FIG. 1B. In the example of FIG. 2, the caption 112 describes content depicted by the pixels of one video frame in the video 102. The caption 112 includes natural language text describing content depicted in the particular video frame, e.g., the central video frame 262.

The system 100 provides at least the caption 112 as input to the summarization model 120 to generate the corresponding annotation 122, as described above with reference to FIG. 1B. Thus in the example of FIG. 2, the corresponding annotation 122 summarizes the content of the text sequences 104 and the content depicted in the central video frame 262.

The system 100 generates the data sample 140 to include the annotation 122 and the video 102, as described above with reference to FIG. 1B. In the example of FIG. 2, the data sample 140 is a paired data sample. For example, the data sample 140 can include <video 102, annotation 122>.

FIG. 3 shows the example data generation system 100 described above with FIG. 1A. In particular, in the example of FIG. 3, the video 102 is longer than a maximum threshold duration, or has a number of video frames that is greater than a maximum threshold number of video frames. The system 100 generates a data sample 140 that includes multiple annotations 122a-n for the video 102 using the video captioning model 110 and the summarization model 120 for each of multiple segments of a video.

The system 100 obtains the video 102 and, in some examples, the text sequences 104 as described above with reference to FIG. 1A.

In the example of FIG. 3, the system 100 identifies one or more segments 362a-n of the video 102 and provides one or more identified key video frames 382a-n of each segment as input to the video captioning model 110.

Each segment includes one or more consecutive video frames of the video 102. Each segment can have a corresponding time range specified by a start timestamp and an end timestamp. As another example, each segment can have a corresponding video frame range specified by a start video frame index and an end video frame index.

As an example, the system 100 can identify the segments 362a-n based on timing. For example, the system 100 can divide the video 102 into the segments 362a-n such that each of the segments 362a-n meet a threshold duration. For example, the threshold duration can have a minimum and maximum length of time.

As another example, the system 100 can identify the segments 362a-n based on the content of speech represented in the video. For example, the system 100 can divide the video 102 into the segments 362a-n such that each of the segments 362a-n represents relevant speech in the context of the speech represented by the video.

For example, the system 100 can obtain a transcript of speech represented in the video. The system 100 can identify the segments 362a-n based on one or more portions of text in the transcript. Each portion of text corresponds to one of the segments 362a-n, i.e., each of the segments 362a-n includes video frames of a corresponding time range for a portion of text. Each portion of text can include relevant text in the context of the transcript.

For example, the system 100 can use a language model neural network to identify the one or more portions of text from the transcript. The system 100 can determine the corresponding time range for the one or more portions of text by determining the start and end timestamps of the portions of text using the text transcript.

As another example, the system 100 can identify the segments 362a-n based on the timing of speech represented in the video. For example, the system 100 can divide the video 102 into the segments 362a-n such that each of the segments 362a-n represents continuous speech.

For example, the system 100 can obtain a transcript of speech represented in the video. Each portion of text can include continuous, i.e., uninterrupted, text in the context of the transcript.

For example, the system 100 can use a language model neural network to identify the one or more portions of text from the transcript. The system 100 can determine the corresponding time range for the one or more portions of text by determining the start and end timestamps of the portions of text using the text transcript.

As another example, each portion of text can include one sentence. The system 100 can extract each sentence from the transcript as a portion of text. The system 100 can determine the corresponding time range for each sentence by determining the start and end timestamps of each sentence using the text transcript.

In some examples, the system 100 can identify the segments 362a-n based on timing and based on one or more portions of text in the transcript. For example, the system 100 can identify the segments 362a-n such that each of the segments 362a-n represents relevant speech in the context of the speech represented by the video, as well as meets the threshold duration.

The system 100 determines one or more key video frames 372. The key video frames 372 are a proper subset of the frames in the video that are representative of the content depicted in the video. For example, a key video frame can be a video frame that depicts the beginning of a new scene in the video, or a video frame that depicts the start of dynamic and fast-changing content, e.g., a video frame that satisfies a threshold difference from the preceding video frame, of the video.

For example, the system 100 can generate, for each video frame of the video 102, a respective frame embedding. For example, the system 100 can use a video encoder neural network to generate the respective frame embeddings.

For each consecutive pair of video frames, the system 100 can determine whether the second video frame of the pair is a key video frame. For example, the system 100 can determine, for each consecutive pair of video frames, a respective difference between the respective frame embedding for a first video frame of the consecutive pair, and the respective frame embedding for a second video frame of the consecutive pair. The system 100 can determine, for each consecutive pair of video frames, whether the respective difference meets a threshold difference. In some examples, the threshold difference is a predetermined value. For each consecutive pair of video frames, if the respective difference meets the threshold difference, the system 100 can determine that the second video frame of the consecutive pair is a key video frame.

For each of one or more segments 362a-n, the system 100 provides one or more video frames of the segment as input to the video captioning model 110. For example, the system 100 can provide one or more identified key video frames 382a-n that belong to the segment as input to the video captioning model 110. For example, the identified key video frames 382a can belong to the segment 362a.

The system 100 can identify one or more of the key video frames 372 as belonging to the segment. For example, the system 100 can determine that one of the key video frames 372 belongs to the segment if the timestamp of the key video frame falls within the time range of the segment. As another example, the system 100 can determine that one of the key video frames 372 belongs to the segment if the video frame index of the key video frame falls within the video frame range of the segment.

For each segment 362a-n for which the system 100 identified key video frames, the system 100 provides one or more of the identified key video frames 382a-n for the segment as input to the video captioning model 110 to generate a set of one or more captions 112a-n for the segment, as described above with reference to FIG. 1B. In some examples, the system 100 provides, for each identified key video frame for a segment, the identified key video frame as input to the video captioning model 110. For example, the system 100 provides each of the identified key video frames 382a for the segment 362a as input to the video captioning model 110 to generate a corresponding respective caption for inclusion in the set of respective captions 112a. In the example of FIG. 3, each of the captions in the set of respective captions describes content depicted in a segment of the video 102, e.g., depicted by the pixels of one or more of the video frames in the segment. Each respective caption for a segment describes content depicted by the corresponding identified key video frame for the respective caption.

In some examples, the system 100 provides the identified key video frames for a segment as input to the video captioning model 110. In these examples, the set of captions for the segment includes one caption. The caption for the segment describes content depicted by the identified key video frames for the segment.

For one or more of the segments 362a-n, the system 100 provides at least the set of captions 112a-n as input to the summarization model 120 to generate a corresponding annotation 122a-n, as described above with reference to FIG. 1B. For example, the system 100 provides the captions 112a and, in some examples, the text sequences 104 as input to the summarization model 120 to generate the corresponding annotation 122a. Thus in the example of FIG. 3, each annotation 122a-n summarizes the content of the text sequences 104 and the content depicted in the identified key video frames 382a-n that belong to the segment 362a-n.

The system 100 generates the data sample 140 to include the annotations 122a-n and the segments 362a-n. In some examples, as described above with reference to FIG. 1B, the system 100 is configured to generate a paired data sample 140. For example, the system 100 can generate a combined annotation by combining, e.g., concatenating, each annotation 122a-n. The system 100 can generate the paired data sample 140 to include <video 102, combined annotation>.

In some examples, the system 100 is configured to generate an interleaved data sample 140. For example, the system 100 can generate a combined annotation by combining, e.g., concatenating, each annotation 122a-n. The system 100 can include one or more indices in the combined annotation, where each index identifies a corresponding segment of the video. As an example, the combined annotation can include an index for the first segment 362a, “[frames clip #1]”, followed by the corresponding annotation 122a, an index for the second segment 362b, “[frames clip #2]”, followed by the corresponding annotation 122b, and so on for the segments 362c-n.

The system 100 can generate the interleaved data sample 140 to include the video 102 and the annotations 122a-n, in an interleaved format. For example, the system 100 can include, at each of the one or more indices, data representing the corresponding segment of the video identified by the index. As a particular example, the interleaved example 140 can include the video frames of the first segment 362a, followed by the corresponding annotation 122a, the video frames of the second segment 362b, followed by the corresponding annotation 122b, and so on for the segments 362c-n.

In some examples, the interleaved data sample 140 can also include data representing an audio signal of the video 102. The data representing an audio signal can include audio samples of the audio signal, or audio tokens representing the audio samples of the audio signal.

For example, the system 100 can generate the interleaved data sample 140 to include the video 102, the annotations 122a-n, and an audio signal of the video 102, in an interleaved format. For example, the system 100 can include, at each of the one or more indices, data representing the corresponding segment of the video identified by the index, and data representing the corresponding audio signal of the corresponding segment. As a particular example, the interleaved example 140 can include the video frames of the first segment 362a, followed by the corresponding annotation 122a and the corresponding audio signal of the first segment 362a, the video frames of the second segment 362b, followed by the corresponding annotation 122b and the corresponding audio signal of the second segment 362b, and so on for the segments 362c-n.

In some examples, the system 100 can use the interleaved data sample 140 as a training sample for tasks such as streaming video processing, e.g., generating at least part of a video caption for an input video after receiving at least some of the video frames of the input video. Because video frames of each segment are interleaved with the corresponding annotation for the segment, and in some examples, data representing the audio signal for the segment, the interleaved data samples allow for training the video processing model 150 to perform streaming video processing.

In some examples, the system 100 can generate training samples that include different combinations of data from the data sample 140. For example, for a task such as video captioning, the system 100 can generate training samples that each include a particular segment of a video as a training input and the corresponding annotation as the training output.

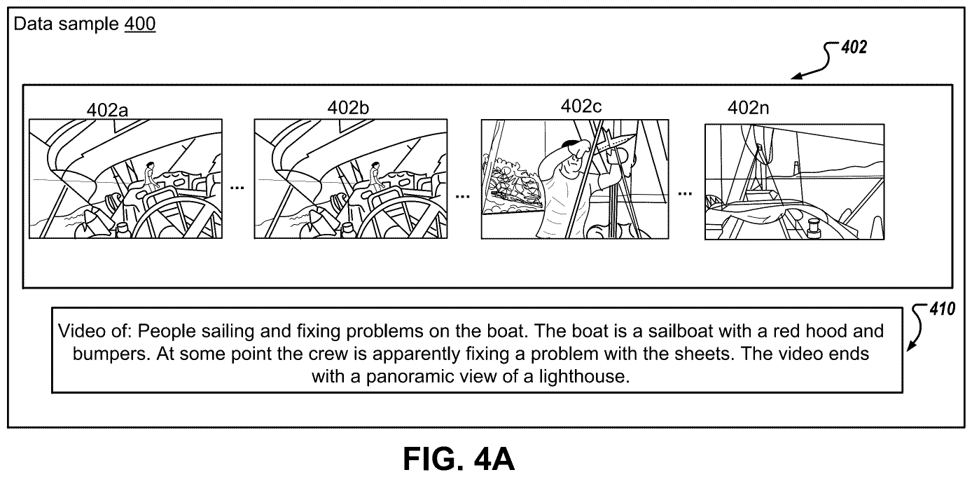

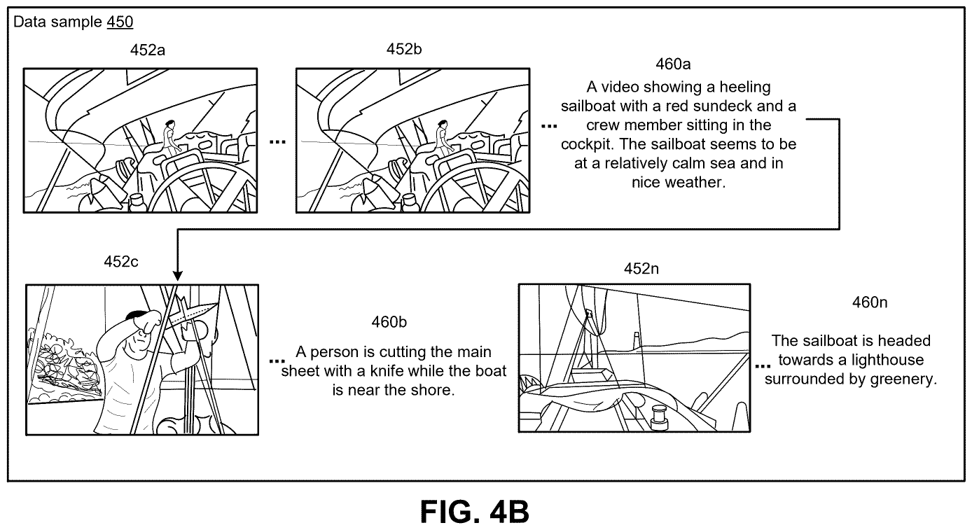

FIG. 4A shows an example data sample 400. The data sample 400 is an example of the data sample 140 described above with reference to FIG. 1A. In particular, the data sample 400 is a paired data sample, as described with reference to FIG. 1B and FIG. 2.

The data sample 400 includes multiple video frames of a video such as the video frames 402a, 402b, 402c, and 402n. The data sample 400 also includes the annotation 410, summarizing the content of the video frames 402a-n and, in some examples, text sequences such as the text sequences 104 described above with reference to FIG. 1A. The annotation 410 includes the text “Video of: People sailing and fixing problems on the boat. The boat is a sailboat with a red hood and bumpers. At some point the crew is apparently fixing a problem with the sheets. The video ends with a panoramic view of a lighthouse.”

FIG. 4B shows another example data sample 450. The data sample 450 is an example of the data sample 140 described above with reference to FIG. 1A. In particular, the data sample 450 is an interleaved data sample, as described with reference to FIG. 3.

The data sample 450 includes video frames 452a-n interleaved with annotations 460a-n. For example, video frames 452a and 452b can belong to a first segment of a video. In particular, the video frames 452a and 452b are key video frames belonging to the first segment, as described above with respect to FIG. 3. The annotation 460a is the corresponding annotation for the first segment, which summarizes the content depicted in the key video frames of the first segment. In some examples, the annotation 460a summarizes the content depicted in the key video frames of the first segment and text sequences such as the text sequences 104 described above with reference to FIG. 1A.

Video frame 452c belongs to a second segment of the video. In particular, the video frame 452c is a key video frame belonging to the second segment. The annotation 460b is the corresponding annotation for the second segment, which summarizes the content depicted in the key video frames of the second segment. In some examples, the annotation 460b summarizes the content depicted in the key video frames of the second segment and the text sequences.

Video frame 452n belongs to an n-th segment of the video. In particular, the video frame 452n is a key video frame belonging to the n-th segment. The annotation 460n is the corresponding annotation for the n-th segment, which summarizes the content depicted in the key video frames of the n-th segment. In some examples, the annotation 460n summarizes the content depicted in the key video frames of the n-th segment and the text sequences.

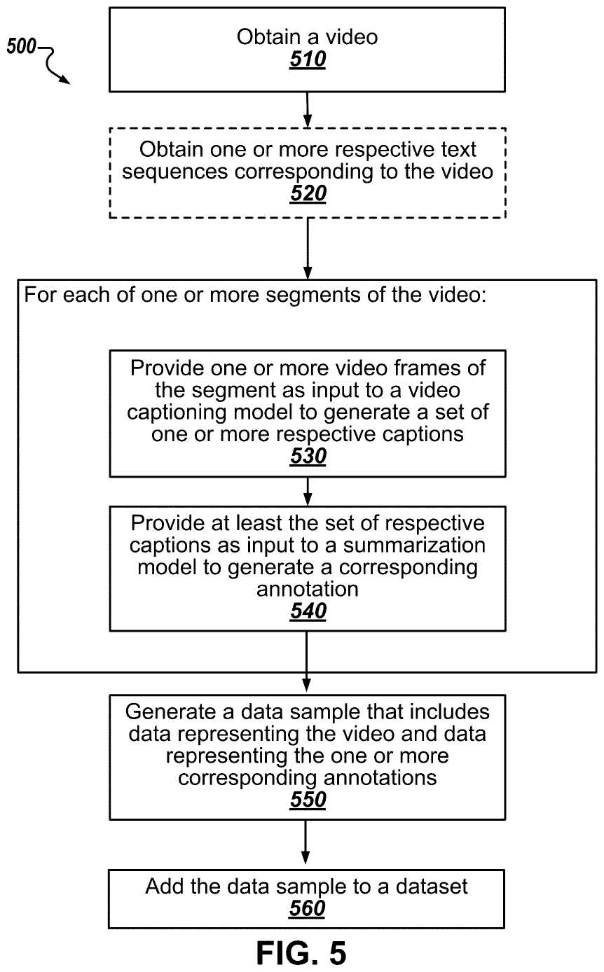

FIG. 5 is a flow diagram of an example process 500 for generating a dataset of data samples. For convenience, the process 500 will be described as being performed by a system of one or more computers located in one or more locations. For example, a data generation system, e.g., the data generation system 100 depicted in FIGS. 1A-1B, and FIGS. 2-3, appropriately programmed in accordance with this specification, can perform the process 500.

The system obtains a video (step 510). The video includes multiple video frames.

In some examples, the system also obtains one or more respective text sequences corresponding to the video (step 520). The text sequences can include, for example, a title of the video, a description of the video, one or more entities depicted in the video, or a transcript of speech represented in the video.

The system performs steps 530-540 for each of one or more segments of the video. Each segment includes one or more consecutive video frames of the video.

In some examples, such as described with reference to FIG. 1B and FIG. 2, the video includes one segment. In some examples, such as described with reference to FIG. 3, the video can include multiple segments.

In some implementations, the system can identify the segments based on one or more portions of text in a transcript of speech represented in the video. In some implementations, the system can divide the video into the one or more segments based on a threshold duration for the segments.

For each of the one or more segments, the system provides one or more video frames of the segment as input to a video captioning model to generate a set of one or more respective captions (step 530). Each respective caption describes content depicted in the segment.

In some examples, the system provides all of the video frames of the segment as input to the video captioning model. In some examples, the video includes one segment, and the system provides all of the video frames of the video as input to the video captioning model. In these examples, the set includes one caption that describes content depicted in the video.

In some examples, the system provides a particular video frame of the segment as input to the video captioning model. In some examples, such as described with reference to FIG. 2, the system provides the central video frame of the video as input to the video captioning model. In these examples, the set includes one caption that describes content depicted in the central video frame of the video.

In some examples, such as described with reference to FIG. 3, the system provides one or more identified key video frames of the segment as input to the video captioning model. For example, for each identified key video frame of the segment, the system can provide the identified key video frame as input to the video captioning model. In these examples, the set includes a respective caption for each of the identified key video frames that describes content depicted in the key video frame of the video. As another example, the system can provide the identified key video frames of the segment as input to the video captioning model. In these examples, the set includes one caption that describes content depicted in the identified key video frames.

For each of the one or more segments, the system provides at least the set of respective captions as input to a summarization model to generate a corresponding annotation (step 540). The corresponding annotation is a summary of at least the set of respective captions. In some examples, the system provides the set of respective captions and the one or more respective text sequences as input to the summarization model to generate the corresponding annotation. In these examples, the corresponding annotation is a summary of the set of respective captions and the one or more respective text sequences.

The system generates a data sample that includes at least data representing the video and data representing the one or more corresponding annotations (step 550). The data representing the video can include the video frames of the video, or a sequence of video tokens representing the video frames of the video. The data representing the corresponding annotation for each of the one or more segments of the video can include text, or a sequence of text tokens representing the text.

In some examples, the data sample can also include data representing an audio signal of the video. The data representing the audio signal can include audio frames of the audio signal, or audio tokens representing the audio frames of the audio signal.

In some examples, the data sample is a paired data sample, as shown in FIG. 4A. In some examples, the example is an interleaved data sample, as shown in FIG. 4B.

The system adds the data sample to a dataset (step 560).

In some examples, the system can generate training data for training a video processing model from the dataset. For example, for a video captioning task, the system can generate a training sample from a data sample by including the video of the data sample as the training input of the training sample, and the annotations of the data sample as the training output of the training sample. The system can train the video processing model on the training data.

In some examples, the system can generate the dataset for a particular type of video. For example, the system can obtain videos that have a similar length or number of frames, a particular video resolution, or videos that are similar to each other, e.g., include video frames that are close to each other in an embedding space.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

In addition to the embodiments described above, the following embodiments are also innovative:
Embodiment 1 is a computer-implemented method comprising: obtaining a video that comprises a plurality of video frames; for each of one or more segments of the video, wherein each segment comprises one or more consecutive video frames of the video: providing one or more video frames of the segment as input to a video captioning model to generate a set of one or more respective captions, each describing content depicted in the segment; providing at least the set of respective captions as input to a summarization model to generate a corresponding annotation for the segment; and generating a data sample comprising at least data representing the video and data representing the corresponding annotation for each of the one or more segments of the video; and adding the data sample to a dataset.
Embodiment 2 is the method of embodiment 1, further comprising: generating, from the dataset, training data for training a video processing model; and training the video processing model on the training data.
Embodiment 3 is the method of embodiment 2, wherein the video processing model is the video captioning model.
Embodiment 4 is the method of any of embodiments 1-3, wherein the one or more segments of the video are identified from the video by: obtaining a transcript of speech represented in the video; and identifying the one or more segments based on one or more portions of text in the transcript, each corresponding to a segment of the video.
Embodiment 5 is the method of embodiment 4, wherein identifying the one or more segments based on one or more portions of text in the transcript comprises identifying the one or more segments based on a respective timing of the one or more portions of text.
Embodiment 6 is the method of any of embodiments 1-5, wherein the one or more segments of the video are identified from the video by dividing the video into the one or more segments that each meet a threshold duration.
Embodiment 7 is the method of any of embodiments 1-6, wherein providing one or more video frames of the segment as input to the video captioning model comprises providing the plurality of video frames of the video as input to the video captioning model.
Embodiment 8 is the method of any of embodiments 1-7, wherein providing one or more video frames of the segment as input to the video captioning model comprises providing only a particular video frame of the consecutive video frames of the segment as input to the video captioning model.
Embodiment 9 is the method of any of embodiments 1-8, further comprising determining one or more key video frames of the video by: generating, for each video frame of the video, a respective frame embedding; determining, for each consecutive pair of video frames, a respective difference between the respective frame embedding for a first video frame of the consecutive pair, and the respective frame embedding for a second video frame of the consecutive pair; determining, for each consecutive pair of video frames, whether the respective difference meets a threshold difference; and for each consecutive pair of video frames, in response to determining that the respective difference meets a threshold difference, determining that the second video frame of the consecutive pair is a key video frame.
Embodiment 10 is the method of embodiment 9, wherein providing one or more video frames of the segment as input to the video captioning model comprises: identifying one or more of the key video frames as belonging to the segment; and providing one or more of the identified key video frames as input to the video captioning model.
Embodiment 11 is the method of any of embodiments 1-10, wherein generating a data sample comprising at least data representing the video and data representing the corresponding annotation for each of the one or more segments of the video comprises generating a combined annotation by combining each corresponding annotation.
Embodiment 12 is the method of embodiment 11, wherein the combined annotation comprises one or more indices, each identifying a corresponding segment of the video.
Embodiment 13 is the method of embodiment 12, wherein generating a data sample comprising at least data representing the video and data representing the corresponding annotation for each of the one or more segments of the video further comprises including, at each of the one or more indices, data representing the corresponding segment of the video identified by the index.
Embodiment 14 is the method of embodiment 12, wherein generating a data sample comprising at least data representing the video and data representing the corresponding annotation for each of the one or more segments of the video further comprises including, at each of the one or more indices, data representing a corresponding audio signal of the corresponding segment of the video identified by the index.
Embodiment 15 is the method of embodiment 14, wherein data representing the corresponding audio signal comprises one or more audio samples of the corresponding audio signal, or a sequence of audio tokens representing the audio samples of the corresponding audio signal.
Embodiment 16 is the method of any of embodiments 1-15, wherein data representing the video comprises the video frames of the video, or a sequence of video tokens representing the video frames of the video.
Embodiment 17 is the method of any of embodiments 1-16, wherein data representing, for each of the one or more segments of the video, the corresponding annotation, comprises text, or a sequence of text tokens representing the text.
Embodiment 18 is the method of any of embodiments 1-17, further comprising obtaining one or more respective text sequences corresponding to the video, and wherein providing at least the set of respective captions as input to a summarization model to generate a corresponding annotation for the segment comprises providing the set of respective captions and the one or more respective text sequences as input to the summarization model.
Embodiment 19 is the method of embodiment 18, wherein the one or more respective text sequences comprise any one or more of: a title of the video, a description of the video, text specifying one or more entities depicted in the video, or a transcript of speech represented in the video.
Embodiment 20 is a system comprising one or more computers and one or more storage devices storing instructions that are operable, when executed by the one or more computers, to cause the one or more computers to perform operations of the respective method of any of embodiments 1-19.
Embodiment 21 is one or more non-transitory computer storage media encoded with computer program instructions that when executed by a plurality of computers cause the plurality of computers to perform operations of the respective method of any of embodiments 1-19.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
obtaining a video that comprises a plurality of video frames;
for each of one or more segments of the video, wherein each segment comprises one or more consecutive video frames of the video:
providing one or more video frames of the segment as input to a video captioning model to generate a set of one or more respective captions, each describing content depicted in the segment;
providing at least the set of respective captions as input to a summarization model to generate a corresponding annotation for the segment; and
generating a data sample comprising at least data representing the video and data representing the corresponding annotation for each of the one or more segments of the video; and
adding the data sample to a dataset.

2. The method of claim 1, further comprising:
generating, from the dataset, training data for training a video processing model; and
training the video processing model on the training data.

3. The method of claim 2, wherein the video processing model is the video captioning model.

4. The method of claim 1, wherein the one or more segments of the video are identified from the video by:
obtaining a transcript of speech represented in the video; and
identifying the one or more segments based on one or more portions of text in the transcript, each corresponding to a segment of the video.

5. The method of claim 4, wherein identifying the one or more segments based on one or more portions of text in the transcript comprises identifying the one or more segments based on a respective timing of the one or more portions of text.

6. The method of claim 1, wherein the one or more segments of the video are identified from the video by dividing the video into the one or more segments that each meet a threshold duration.

7. The method of claim 1, wherein providing one or more video frames of the segment as input to the video captioning model comprises providing the plurality of video frames of the video as input to the video captioning model.

8. The method of claim 1, wherein providing one or more video frames of the segment as input to the video captioning model comprises providing only a particular video frame of the consecutive video frames of the segment as input to the video captioning model.

9. The method of claim 1, further comprising determining one or more key video frames of the video by:
generating, for each video frame of the video, a respective frame embedding;
determining, for each consecutive pair of video frames, a respective difference between the respective frame embedding for a first video frame of the consecutive pair, and the respective frame embedding for a second video frame of the consecutive pair;
determining, for each consecutive pair of video frames, whether the respective difference meets a threshold difference; and
for each consecutive pair of video frames, in response to determining that the respective difference meets a threshold difference, determining that the second video frame of the consecutive pair is a key video frame.

10. The method of claim 9, wherein providing one or more video frames of the segment as input to the video captioning model comprises:
identifying one or more of the key video frames as belonging to the segment; and
providing one or more of the identified key video frames as input to the video captioning model.

11. The method of claim 1, wherein generating a data sample comprising at least data representing the video and data representing the corresponding annotation for each of the one or more segments of the video comprises generating a combined annotation by combining each corresponding annotation.

12. The method of claim 11, wherein the combined annotation comprises one or more indices, each identifying a corresponding segment of the video.

13. The method of claim 12, wherein generating a data sample comprising at least data representing the video and data representing the corresponding annotation for each of the one or more segments of the video further comprises including, at each of the one or more indices, data representing the corresponding segment of the video identified by the index.

14. The method of claim 12, wherein generating a data sample comprising at least data representing the video and data representing the corresponding annotation for each of the one or more segments of the video further comprises including, at each of the one or more indices, data representing a corresponding audio signal of the corresponding segment of the video identified by the index.

15. The method of claim 14, wherein data representing the corresponding audio signal comprises one or more audio samples of the corresponding audio signal, or a sequence of audio tokens representing the audio samples of the corresponding audio signal.

16. The method of claim 1, wherein data representing the video comprises the video frames of the video, or a sequence of video tokens representing the video frames of the video.

17. The method of claim 1, wherein data representing, for each of the one or more segments of the video, the corresponding annotation, comprises text, or a sequence of text tokens representing the text.

18. The method of claim 1, further comprising obtaining one or more respective text sequences corresponding to the video, and wherein providing at least the set of respective captions as input to a summarization model to generate a corresponding annotation for the segment comprises providing the set of respective captions and the one or more respective text sequences as input to the summarization model.

19. The method of claim 18, wherein the one or more respective text sequences comprise any one or more of: a title of the video, a description of the video, text specifying one or more entities depicted in the video, or a transcript of speech represented in the video.

20. A system comprising one or more computers and one or more storage devices storing instructions that are operable, when executed by the one or more computers, to cause the one or more computers to perform operations comprising:
obtaining a video that comprises a plurality of video frames;
for each of one or more segments of the video, wherein each segment comprises one or more consecutive video frames of the video:
providing one or more video frames of the segment as input to a video captioning model to generate a set of one or more respective captions, each describing content depicted in the segment;
providing at least the set of respective captions as input to a summarization model to generate a corresponding annotation for the segment; and
generating a data sample comprising at least data representing the video and data representing the corresponding annotation for each of the one or more segments of the video; and
adding the data sample to a dataset.

21. One or more non-transitory computer storage media encoded with computer program instructions that when executed by a plurality of computers cause the plurality of computers to perform operations comprising:
obtaining a video that comprises a plurality of video frames;
for each of one or more segments of the video, wherein each segment comprises one or more consecutive video frames of the video:
providing one or more video frames of the segment as input to a video captioning model to generate a set of one or more respective captions, each describing content depicted in the segment;
providing at least the set of respective captions as input to a summarization model to generate a corresponding annotation for the segment; and
generating a data sample comprising at least data representing the video and data representing the corresponding annotation for each of the one or more segments of the video; and
adding the data sample to a dataset.
